(19) United States
(12) Patent Application Publication
(10) Pub. No.: US 2026/0108996 A1
(43) Pub. Date: Apr. 23, 2026

(54) CASSETTE TRANSPORT SYSTEM

(71) Applicant: Samsung Display Co., LTD., Yongin-si (KR)

(72) Inventor: Su Sun CHOI, Yongin-si (KR)

(21) Appl. No.: 19/230,452

(22) Filed: Jun. 6, 2025

(30) Foreign Application Priority Data
Oct. 18, 2024 (KR) 10-2024-0143103

(51) Int. Cl. B23Q 7/10; B23Q 7/12; B23Q 7/14

(52) U.S. Cl. CPC B23Q 7/10; B23Q 7/12; B23Q 7/14

(57) ABSTRACT

A cassette transport system includes stockers which stores cassettes accommodating substrates therein, processing apparatuses respectively connected to the stockers, and a controller which controls transportation of the cassettes. The controller selects, as a first stocker, a stocker of which a storage modulus is greater than or equal to a reference storage modulus among the stockers, and controls dischargeable cassettes among the cassettes stored in the first stocker to be sequentially discharged from the first stocker according to a predetermined order.

### BACKGROUND

This application claims priority to Korean Patent Application No. 10-2024-0143103 filed on Oct. 18, 2024, and all the benefits accruing therefrom under 35 U.S.C. § 119, the content of which in its entirety is herein incorporated by reference.

### 1. Field

Embodiments of the invention generally relate to a cassette transport system.

### 2. Description of the Related Art

Substrates used in display devices may be transported to several processing apparatuses in a state in which the substrates are loaded into a cassette during a manufacturing process. The substrates loaded into the cassette may be arbitrarily stored in several stockers due to a reason such as that processes have already been performed in other processing apparatuses.

### SUMMARY

In order to improve the efficiency of a manufacturing process of substrates, it may be desired to smoothly perform transportation of cassettes into which substrates are loaded.

Embodiments provide a cassette transport system, which can prevent a transportation delay of cassettes.

In accordance with an embodiment of the invention, a cassette transport system includes: stockers which store cassettes accommodating substrates therein; processing apparatuses respectively connected to the stockers; and a controller which controls a transportation of the cassettes, where the controller selects, as a first stocker, a stocker of which storage modulus is greater than or equal to a reference storage modulus among the stockers, and controls dischargeable cassettes among the cassettes stored in the first stocker to be sequentially discharged from the first stocker according to a predetermined order.

In an embodiment, the dischargeable cassettes may include a first cassette, a second cassette, a third cassette, a fourth cassette, a fifth cassette, and a sixth cassette. In such an embodiment, the first cassette may be a cassette to be used in a processing apparatus connected to a second stocker different from the first stocker among the stockers. In such an embodiment, the second cassette may be a cassette expected to be used in a processing apparatus connected to a third stocker different from the first stocker among the stockers. In such an embodiment, the third cassette may be a cassette which is not used in a processing apparatus connected to the first stocker. In such an embodiment, the fourth cassette may be a cassette subject to cleaning. In such an embodiment, the fifth cassette may be a cassette expected to be cleaned. In such an embodiment, the sixth cassette may be a cassette stored in the first stocker over a time exceeding a predetermined time.

In an embodiment, the controller may control the first cassette first in the predetermined order among the dischargeable cassettes to be discharged from the first stocker to the second stocker.

In an embodiment, when a storage modulus of the second stocker is lower than the reference storage modulus, the controller may control the first cassette not to be discharged from the first stocker.

In an embodiment, the controller may control the second cassette second in the predetermined order among the dischargeable cassettes to be discharged from the first stocker to the third stocker.

In an embodiment, when a storage modulus of the third stocker is lower than the reference storage modulus, the controller may control the second cassette not to be discharged from the first stocker.

In an embodiment, the controller may control the third cassette third in the predetermined order among the dischargeable cassettes to be discharged from the first stocker to a predetermined fourth stocker among the stockers.

In an embodiment, when a storage modulus of the fourth stocker is lower than the reference storage modulus, the controller may control the third cassette not to be discharged from the first stocker.

In an embodiment, the controller may control the fourth cassette fourth in the predetermined order among the dischargeable cassettes to be discharged from the first stocker to a fifth stocker among the stockers.

In an embodiment, when a storage modulus of the fifth stocker is lower than the reference storage modulus, the controller may control the fourth cassette not to be discharged from the first stocker.

In an embodiment, the controller may control the fifth cassette fifth in the predetermined order among the dischargeable cassettes to be discharged from the first stocker to the fifth stocker.

In an embodiment, when a storage modulus of the fifth stocker is lower than the reference storage modulus, the controller may control the fifth cassette not to be discharged from the first stocker.

In an embodiment, the controller may control the sixth cassette sixth in the predetermined order among the dischargeable cassettes to be discharged from the first stocker to a sixth stocker among the stockers.

In an embodiment, when a storage modulus of the sixth stocker is lower than the reference storage modulus, the controller may control the sixth cassette not to be discharged from the first stocker.

In accordance with an embodiment of the invention, a cassette transport system includes: stockers disposed on a plurality of floors in a factory, where the stockers store cassettes accommodating substrates therein; processing apparatuses respectively connected to the stockers; and a controller which controls a transportation of the cassettes, based on a total transport volume of the cassettes calculated for each floor, where the controller controls cassettes stored in a normal stocker among stockers disposed on a corresponding floor not to be discharged, when the total transport volume is greater than a first reference volume, and controls at least one of cassettes stored in a predetermined stocker among the stockers disposed on the corresponding floor to be discharged, when the total transport volume is greater than the first reference volume and is smaller than a second reference volume greater than the first reference volume.

In an embodiment, when the total transport volume is greater than the second reference volume, the controller may control the cassettes stored in the predetermined stocker not to be discharged.

In an embodiment, the controller may control at least one of the cassettes stored in the normal stocker to be transported to the predetermined stocker.

### BRIEF DESCRIPTION OF THE DRAWINGS

The above and other features of embodiments of the invention will become more apparent by describing in further detail embodiments thereof with reference to the accompanying drawings, in which:

FIG. 1 is a diagram schematically illustrating a cassette transport system in accordance with an embodiment of the disclosure;

FIG. 2 is a diagram illustrating a storage modulus of a stocker in accordance with an embodiment of the disclosure;

FIGS. 3 to 11 are diagrams illustrating a logic of the cassette transport system shown in FIG. 1 in accordance with an embodiment of the disclosure;

FIG. 12 is a diagram schematically illustrating a cassette transport system in accordance with an embodiment of the disclosure; and

FIGS. 13 to 17 are diagram illustrating a logic of the cassette transport system shown in FIG. 12 in accordance with an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

In the entire specification, when an element is referred to as being “connected” or “coupled” to another element, it can be directly connected or coupled to the another element or be indirectly connected or coupled to the another element with one or more intervening elements interposed therebetween.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from X, Y, and Z” can be construed as X only, Y only, Z only, or any combination of two or more items X, Y, and Z (e.g., XYZ, XYY, YZ, ZZ).

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In addition, the embodiments of the disclosure are described here with reference to schematic diagrams of ideal embodiments (and an intermediate structure) of the disclosure, so that changes in a shape as shown due to, for example, manufacturing technology and/or a tolerance may be expected. Therefore, the embodiments of the disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

Hereinafter, embodiments of the invention will be described in detail with reference to the accompanying drawings.

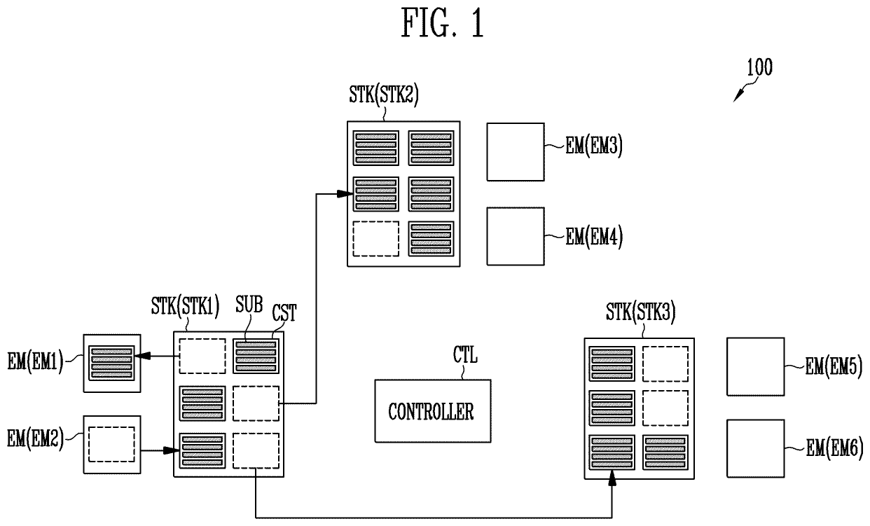

FIG. 1 is a diagram schematically illustrating a cassette transport system in accordance with an embodiment of the disclosure.

Referring to FIG. 1, an embodiment of a cassette transport system 100 may be a transport system for transporting and storing an object before/after a manufacturing process of the object. In an embodiment, for example, the cassette transport system 100 may be transport system for transporting and storing substrates SUB in a manufacturing process of a display device. However, embodiments are not necessarily limited thereto. In another embodiment, for example, the cassette transport system 100 may be widely applied to a transport system during a semiconductor manufacturing process or various transport systems of other objects.

In an embodiment, the cassette transport system 100 may include stockers STK, processing apparatuses EM, and a controller CTL.

The cassette transport system 100 may include a plurality of stockers STK. For convenience of illustration and descriptions, three stocker STK are illustrated in FIG. 1 as an example. In an embodiment, for example, as shown in in FIG. 1, the cassette transport system 100 includes a first stocker STK1, a second stocker STK2, and a third stocker STK3. However, embodiments are not necessarily limited thereto. The number of stockers STK included in the cassette transport system 100 may be changed according to the manufacturing process of the display device, the size of a factory in which the manufacturing process is performed, or the like.

The stockers STK may store (or keep) a plurality of cassettes CST therein. In an embodiment, for example, shelves for storing the cassettes CST may be provided in the stockers STK, and the cassettes CST may be located on the shelves. For convenience of illustration and description, an embodiment where numbers of cassettes CST storable in the respective three stockers STK are the same as each other is shown in FIG. 1. In an embodiment, for example, as shown in FIG. 1, each of the first stocker STK1, the second stocker STK2, and the third stocker STK3 may store a maximum of six cassettes CST. However, embodiments are not necessarily limited thereto. The numbers of cassettes CST storable in the respective stockers STK may be the same or different from each other according to a specification of each of the stockers STK (e.g., a number of shelves).

The cassettes CST may accommodate a plurality of substrates therein. For convenience of illustration and description, an embodiment where numbers of substrates SUB accommodated in the respective cassettes CST are the same as each other is shown in FIG. 1. In an embodiment, for example, as shown in FIG. 1, each of the cassettes CST may accommodate four substrates SUB therein. However, embodiments are not necessarily limited thereto. The numbers of substrates SUB accommodated in the respective cassettes CST may be the same or different from each other according to a specification of each of the cassettes CST (e.g., a size).

The substrate SUB may be base members used for the display device. In an embodiment, for example, the substrates SUB may be glass substrates, but embodiments are not necessarily limited thereto. In an embodiment, for example, the substrates SUB may be substrates including or made of various materials, such as a polyimide (PI) substrate and a silicon substrate.

The processing apparatuses EM may perform processes on the substrates SUB. The processes performed by the processing apparatuses EM may be different from each other, but embodiments are not necessarily limited thereto. The processing apparatuses EM may be connected to corresponding stockers STK, respectively. In an embodiment, for example, a first processing apparatus EM1 and a second processing apparatus EM2 may be connected to the first stocker STK1. The first processing apparatus EM1 and the second processing apparatus EM2 may be supplied with cassettes CST accommodating substrates SUB to be processed from the first stocker STK1 to perform the process. In an embodiment, for example, a third processing apparatus EM3 and a fourth processing apparatus EM4 may be connected to the second stocker STK2. The third processing apparatus EM3 and the fourth processing apparatus EM4 may be supplied with cassettes CST accommodating substrates SUB to be processed from the second stocker STK2 to perform the process. In an embodiment, for example, a fifth processing apparatus EM5 and a sixth processing apparatus EM6 may be connected to the third stocker STK3. The fifth processing apparatus EM5 and the sixth processing apparatus EM6 may be supplied with cassettes CST accommodating substrates SUB to be processed from the third stocker STK3 to perform the process.

The controller CTL may be a system for controlling transportation of the cassette CST (or the substrate SUB). The controller CTL may include an automated dispatching system (ADS), thereby selecting an optimum transport object and an optimum transport destination. Also, the controller CTL may include a material control system (MCS), thereby allowing a transport object to reach a transport destination through an optimum path. In an embodiment, for example, the controller CTL may control a cassette CST for the first processing apparatus EM1 among cassettes CST stored in the first stocker STK1 to be transported to the first processing apparatus EM1. In an embodiment, for example, the controller CTL may control a cassette CST on which a process is completed in the second processing apparatus EM2 to be transported to the first stocker STK1. In an embodiment, for example, the controller CTL may control a cassette CST for the third processing apparatus EM3 and/or the fourth processing apparatus EM4 among cassettes CST stored in the first stocker STK1 to be transported to the second stocker STK2. In an embodiment, for example, the controller CTL may control a cassette CST for the fifth processing apparatus EM5 and/or the sixth processing apparatus EM6 among cassettes CST stored in the first stocker STK1 to be transported to the third stocker STK3.

Although not shown in FIG. 1, the cassette transport system 100 may further include components for transportation of the cassettes CST, such as a track (or path) along which the cassettes CST are transported and a transport apparatus for transporting the cassettes CST.

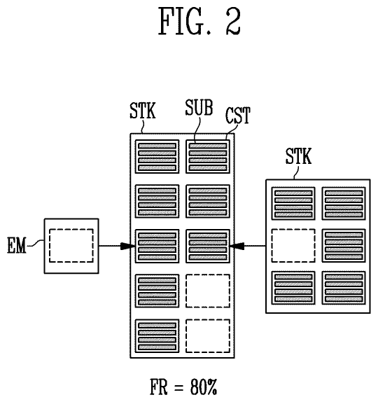

FIG. 2 is a diagram illustrating a storage modulus of a stocker in accordance with an embodiment of the disclosure.

Referring to FIG. 2, in an embodiment, a storage modulus (or storage ratio) FR of a stocker STK may be defined as a ratio of a number of cassettes CST stored in the stocker STK with respect to a maximum number of cassettes CST storable in the stocker STK. The number of cassettes CST stored in the stocker STK may be derived by adding up a number of cassettes CST pre-stored in the stocker STK and a number of cassettes CST transported to the stocker STK from another stocker STK and/or a processing apparatus EM. For example, when the maximum number of cassettes storable in the stocker STK is 10 and the number of cassettes CST stored in the stocker STK is 8, the storage modulus FR of the stocker STK may be 80%.

As the storage modulus FR of stockers STK becomes larger, a storage space of the stockers STK is reduced, and therefore, transportation of cassettes CST may be delayed. Accordingly, an operation rate (or speed) of processing apparatuses EM connected to the stocker STK may be decreased, and processing efficiency may be deteriorated due to accumulation of such a phenomenon or decreased operation rate. In addition, there may be an inconvenience in a case where a worker manually transports the cassettes CST.

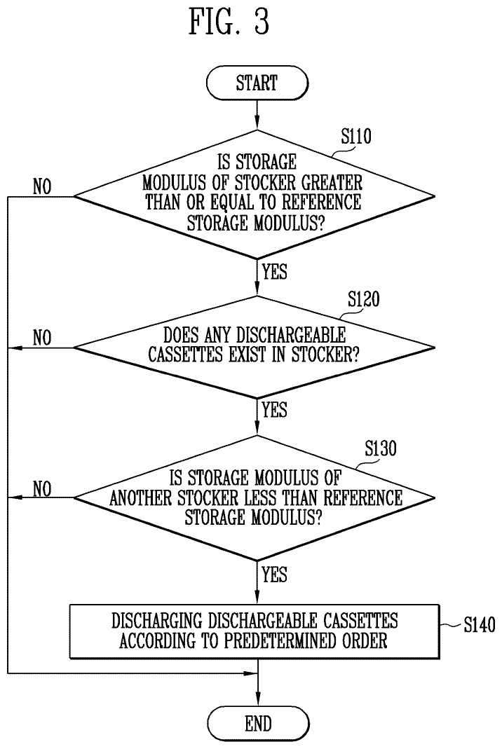

FIGS. 3 to 11 are diagrams illustrating a logic of the cassette transport system shown in FIG. 1 in accordance with an embodiment of the disclosure.

Referring to FIG. 3, in an embodiment, the cassette transport system 100 (see FIG. 1) may perform a process S110 of determining whether a storage modulus of a stocker is greater than or equal to a reference storage modulus, a process S120 of determining whether any dischargeable cassettes exist in the stocker, a process S130 of determining whether a storage modulus of another stocker is lower than the reference storage modulus, and a process S140 of discharging the dischargeable cassettes according to a predetermined order.

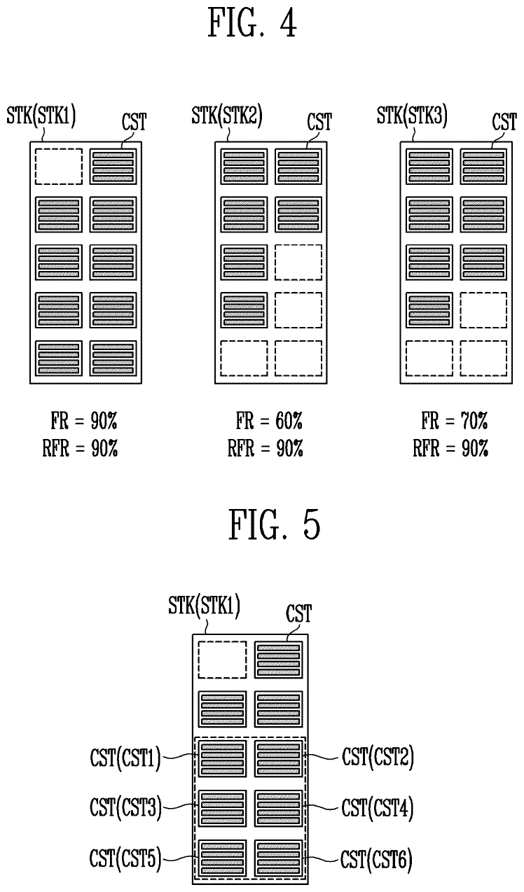

Referring to FIGS. 3 and 4, in the process S110, the controller CTL (see FIG. 1) may select a stocker STK of which storage modulus FR is greater than or equal to a reference storage modulus RFR among stockers STK. The reference storage modulus RFR is a threshold value for securing a storage space of the stockers STK, and may be predetermined to be stored in the controller CTL. For convenience of illustration and description, an embodiment where the reference storage modulus RFR is equally set with respect to the stocker STK is shown in FIG. 4. However, embodiments are not necessarily limited thereto. In another embodiment, for example, the reference storage modulus RFR may be differently set for each of the stockers STK according to specifications of the stocker STK. Hereinafter, embodiments where the reference storage modulus RFR is set to 90% will be described as an example. In such an embodiment, the controller CTL may calculate a storage modulus FR of a first stocker STK1 as 90%, calculate a storage modulus FR of a second stocker STK2 as 60%, and calculate a storage modulus FR of a third stocker STK3 as 70%, as shown in FIG. 4. The controller CTL may select the first stocker STK1 having the storage modulus FR of 90%, which is greater than or equal to the reference modulus rate RFR, among the first to third stockers STK1 to STK3.

Referring to FIGS. 3 to 5, in the process S120, the controller CTL (see FIG. 1) may determine whether any dischargeable cassettes CST exist among cassettes stored in the selected stocker STK. The dischargeable cassettes CST may include a first cassette CST1, a second cassette CST2, a third cassette CST3, a fourth cassette CST4, a fifth cassette CST5, and a sixth cassette CST6. For convenience of illustration and description, a case where the dischargeable first to sixth cassettes CST1 to CST6 are all included in the first stocker STK1 is illustrated in FIG. 5. However, embodiments are not necessarily limited thereto. In another case, for example, one or some of the first to sixth cassettes CST1 to CST6 may be included in the first stocker STK1.

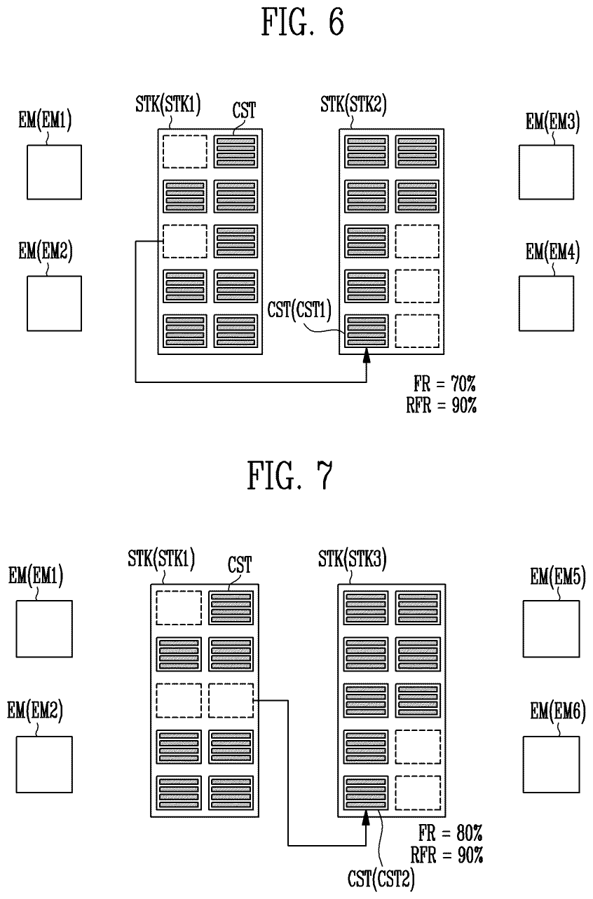

Referring to FIGS. 3 and 6, the first cassette CST1 may be a cassette CST essentially (or to be) used in a process performed in processing apparatuses EM connected to another stocker STK. In an embodiment, for example, the first cassette CST1 may be a cassette CST which is not used in a process performed in a first processing apparatus EM1 and a second processing apparatus EM2, which are connected to the selected first stocker STK1, and is essentially (or to be) used in a process performed in a third processing apparatus EM3 and/or a fourth processing apparatus EM4, which are connected to the second stocker STK2.

In the process S130, the controller CTL (see FIG. 1) may determine whether a storage modulus FR of another stocker STK to which the first cassette CST1 is to be transported is lower than the reference storage modulus RFR. For example, the controller CTL may calculate the storage modulus FR of the second stocker STK2 as 70%, and compare the storage modulus FR of the second stocker STK2 with the reference storage modulus RFR. When the storage modulus FR of the second stocker STK2 is greater than or equal to the reference storage modulus RFR, the controller CTL may inhibit (not allow) transportation of the first cassette CST1.

In the process S140, the controller CTL may control the dischargeable cassettes CST to be discharged according to a predetermined order. The predetermined order defines an order of a cassette CST to be preferentially discharged from a stocker STK selected to secure a storage space, and may be predetermined to be stored in the controller CTL. For example, the controller CTL may control the first cassette CST1 in a first place among the first to sixth cassettes CST1 to CST6 (see FIG. 5) to be discharged from the first stocker STK1 to the second stocker STK2.

Referring to FIGS. 3 to 7, the second cassette CST may be a cassette CST expected to be used in a process performed in processing apparatuses EM connected to another stocker STK. For example, the second cassette CST2 may be a cassette CST which is not used in the process performed in the first processing apparatus EM1 and the second processing apparatus EM2, which are connected to the selected first stocker STK1, and is expected to be used in a process performed in a fifth processing apparatus EM5 and/or a sixth processing apparatus EM6, which are connected to the third stocker STK3 according to scheduling.

In the process S130, the controller CTL (see FIG. 1) may determine whether a storage modulus FR of another stocker STK to which the second cassette CST2 is to be transported is lower than the reference storage modulus RFR. For example, the controller CTL may calculate the storage modulus FR of the third stocker STK3 as 80%, and compare the storage modulus FR of the third stocker STK3 with the reference storage modulus RFR. When the storage modulus FR of the third stocker STK3 is greater than or equal to the reference storage modulus RFR, the controller CTL may inhibit transportation of the second cassette CST2.

In the process S140, the controller CST may control the dischargeable cassettes CST to be discharged according to the predetermine order. For example, the controller CTL may control the second cassette in a second place among the first to sixth cassettes CST1 to CST6 (see FIG. 5) to be discharged from the first socker STK1 to the third stocker STK3.

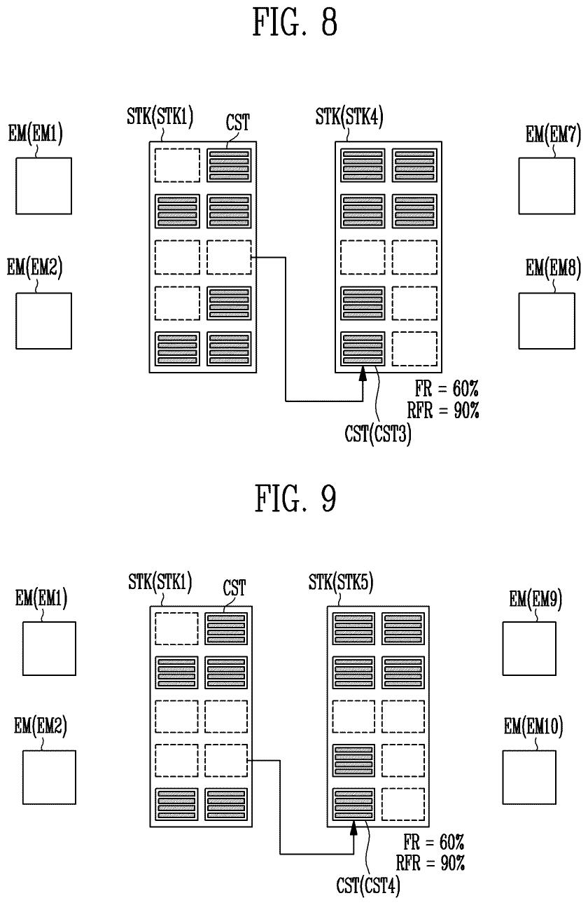

Referring to FIGS. 3 and 8, the third cassette CST3 may be a cassette CST which is not used in the process performed in the processing apparatuses EM connected to the selected stocker STK. For example, the third cassette CST3 may be a cassette CST which is not used in the process performed in the first processing apparatus EM1 and the second processing apparatus EM2, which are connected to the selected first stocker STK1.

In the process S130, the controller CTL (see FIG. 1) may determine whether a storage modulus FR of another stocker STK to which the third cassette CST3 is to be transported is lower than the reference storage modulus RFR. For example, the controller CTL may calculate a storage modulus FR of a fourth stocker STK4 as 60%, and compare the storage modulus FR of the fourth stocker STK4 with the reference storage modulus RFR. The fourth stocker STK4 may be a stocker STK of which storage space is sufficiently secured since the storage modulus FR of the fourth stocker STK4 is low. The fourth stocker STK4 of which storage space is secured may be pre-specified as a transport destination of the third cassette CST3, regardless of whether the third cassette CST3 is used in a process performed in a seventh processing apparatus EM7 and an eighth processing apparatus EM8, which are connected to the fourth stocker STK4. When the storage modulus FR of the fourth stocker STK4 is greater than or equal to the reference storage modulus RFR, the controller CTL may inhibit transportation of the third cassette CST3.

In the process S140, the controller CTL may discharge the dischargeable cassettes CST according to the predetermined order. For example, the controller CTL may control the third cassette CST3 in a third place among the first to sixth cassettes CST1 to CST6 (see FIG. 5) to be discharged from the first socker STK1 to the fourth stocker STK4.

Referring to FIGS. 3 to 9, the fourth cassette CST4 may be a cassette CST subject to cleaning. For example, the fourth cassette CST4 may be a cassette CST which is contaminated by dust or the like since the fourth cassette CST4 has been stored for a long period of time or transported several times.

In the process S130, the controller CTL (see FIG. 1) may determine whether a storage modulus FR of another stocker STK to which the fourth cassette CST4 is to be transported is lower than the reference storage modulus RFR. For example, the controller CTL may calculate a storage modulus FR of a fifth stocker STK5 as 60%, and compare the storage modulus FR of the fifth stocker STK5 with the reference storage modulus RFR. A ninth processing apparatus EM9 and a tenth processing apparatus EM10, which are connected to the fifth stocker STK5, may be cleaning apparatuses. The fifth stocker STK5 connected to the cleansing apparatuses may be pre-specified as a transport destination of the fourth cassette CST4. When the storage modulus FR of the fifth stocker STK5 is greater than or equal to the reference storage modulus RFR, the controller CTL may inhibit transportation of the fourth cassette CST4.

In the process S140, the controller CTL may discharge the dischargeable cassettes according to the predetermined order. For example, the controller CTL may control the fourth cassette CST4 in a fourth place among the first to sixth cassettes CST1 to CST6 (see FIG. 5) to be discharged from the first stocker STK1 to the fifth stocker STK5.

Referring to FIGS. 3 and 10, the fifth cassette CST5 may be a cassette CST expected to be cleaned. For example, the fifth cassette CST5 may be a cassette CST which is not desired to be cleaned since the fifth cassette CST5 has a contamination level lower than a contamination level of the fourth cassette CST4, but will be contaminated soon.

In the process S130, the controller CTL (see FIG. 1) may determine whether a storage modulus FR of another stocker STK to which the fifth cassette CST5 is to be transported is lower than the reference storage modulus RFR. For example, the controller CTL may calculate the storage modulus FR of the fifth stocker STK5 as 60%, and compare the storage modulus FR of the fifth stocker STK5 with the reference storage modulus RFR. The ninth processing apparatus EM9 and the tenth processing apparatus EM10, which are connected to the fifth stocker STK5, may be cleaning apparatuses. The fifth stocker STK5 connected to the cleaning apparatuses may be pre-specified as a transport destination of the fifth cassette CST5. When the storage modulus FR of the fifth stocker STK5 is greater than or equal to the reference storage modulus RFR, the controller CTL may inhibit transportation of the fifth cassette CST5.

In the process S140, the controller CTL may discharge the dischargeable cassettes CST according to the predetermined order. For example, the controller CTL may control the fifth cassette CST5 in a fifth place among the first to sixth cassettes CST1 to CST6 (see FIG. 5) to be discharged from the first stocker STK1 to the fifth stocker STK5.

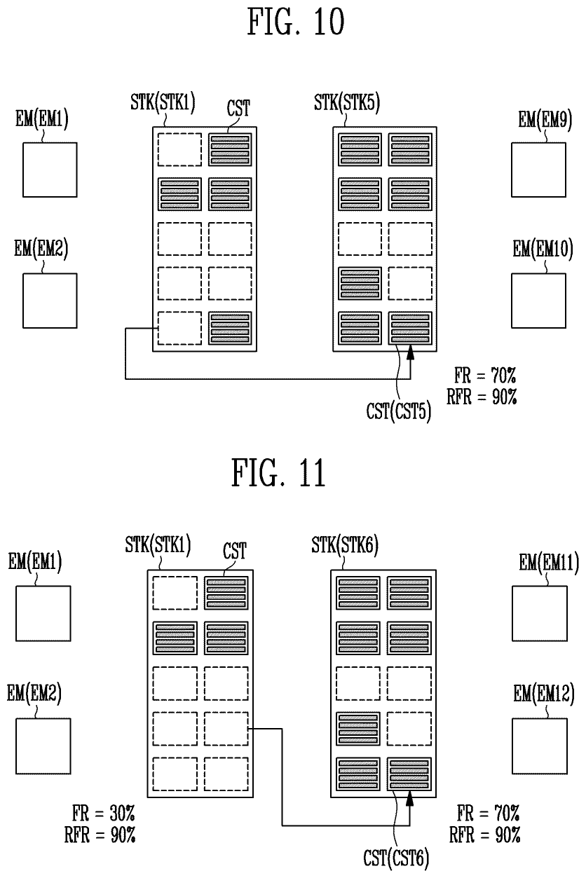

Referring to FIGS. 3 and 11, the sixth cassette CST6 may be a cassette CST stored in the selected stocker STK for a long period of time. For example, the sixth cassette CST6 may be a cassette CST stored in the first stocker STK1 over a time exceeding a predetermined time. The predetermined time may be set by a worker to be pre-stored in the controller CTL (see FIG. 1).

In the process S130, the controller CTL may determine whether a storage modulus FR of another stocker STK to which the sixth cassette CST6 is to be transport is lower than the reference storage modulus RFR. For example, the controller CTL may calculate a storage modulus FR of a sixth stocker STK6 as 70%, and compare the storage modulus FR of the sixth stocker STK6 with reference storage modulus RFR. Similarly to the fourth stocker STK4 (see FIG. 8), the sixth stocker STK6 may be a stocker STK of which storage space is sufficiently secured since the storage modulus FR of the sixth stocker STK6 is low. The sixth stocker STK6 of which storage space is secured may be pre-specified as a transport destination of the sixth cassette CST6, regardless of whether the sixth cassette CST6 is used in a process performed in an eleventh processing apparatus EM11 and a twelfth processing apparatus EM12, which are connected to the sixth stocker STK6. When the storage modulus FR of the sixth stocker STK6 is greater than or equal to the reference storage modulus RFR, the controller CTL may inhibit transportation of the sixth cassette CST6.

In the process S140, the controller CTL may discharge the dischargeable cassettes CST according to the predetermined order. For example, the controller CTL may control the sixth cassette CST6 in a sixth place among the first to sixth cassettes CST1 to CST6 (see FIG. 5) to be discharged from the first stocker STK1 to the sixth stocker STK6.

In an embodiment, as described above, the cassette transport system 100 (see FIG. 1) selects a stocker STK of which storage modulus FR is greater than or equal to the reference storage modulus RFR, and sequentially discharges dischargeable cassettes CST from the corresponding stocker STK according to an order of priority, such that a storage space of the stocker STK can be secured, thereby effectively preventing a transportation delay of the cassettes CST.

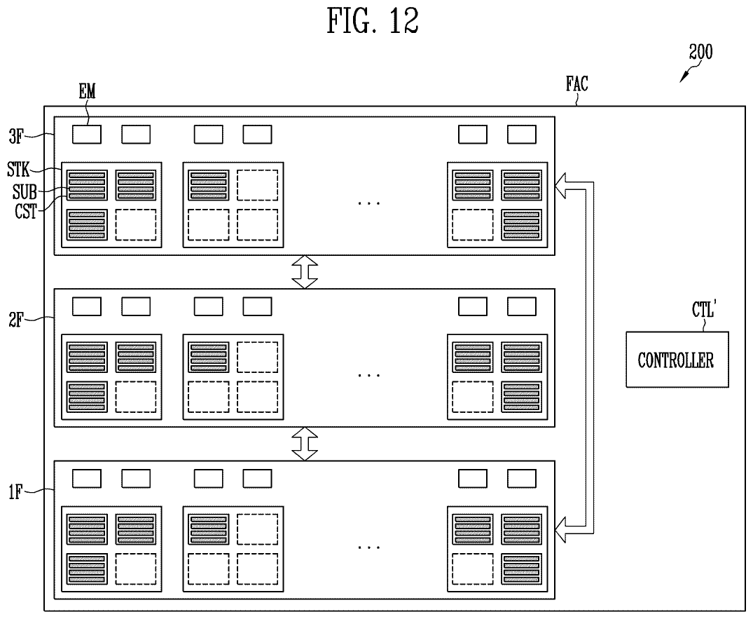

FIG. 12 is a diagram schematically illustrating a cassette transport system in accordance with an embodiment of the disclosure. In description of FIG. 12, any repetitive detailed descriptions of the same or like elements as those described above with reference to FIG. 1 will be simplified or omitted.

Referring to FIG. 12, an embodiment of a cassette transport system 200 may be a transport system for controlling transportation and storage of an object for each floor.

In an embodiment, the cassette transport system 200 may include stockers STK, and processing apparatuses EM, which are disposed on a plurality of floors in a factory FAC, and a controller CTL′ disposed in the factor FAC. For convenience of illustration and description, stockers STK and processing apparatuses EM, which are disposed on three floors in the factory FAC, are illustrated in FIG. 12. In an embodiment, for example, stockers STK in which cassettes CST accommodating substrates SUB therein and processing apparatuses EM performing a process on the substrates SUB may be located on each of a first floor 1F, a second floor 2F, and a third floor 3F in the factory FAC. For convenience of illustration and description, an embodiment where numbers of stockers STK and processing apparatuses EM, which are respectively disposed on the first floor 1F, the second floor 2F, and the third floor 3F, are the same as each other is shown in FIG. 12. However, embodiments are not necessarily limited thereto. For example, the numbers of stockers STK and processing apparatuses EM, which are respectively disposed on the first floor 1F, the second floor 2F, and the third floor 3F, may be different from one another.

The controller CTL′ may be a system for controlling transportation of cassettes CST (or substrates SUB) for each floor. In an embodiment, for example, the controller CTL′ may individually control each of transportation of cassettes CST disposed on the first floor 1F, transportation of cassettes CST disposed on the second floor 2F, and transportation of cassettes CST disposed on the third floor 3F. Also, the controller CST′ may control transportation of cassettes CST between floors. In an embodiment, for example, the controller CTL′ may control transportation of cassettes CST between the first floor 1F and the second floor 2F, transportation of cassettes CST between the second floor 2F and the third floor 3F, and transportation of cassettes CST between the first floor 1F and the third floor 3F.

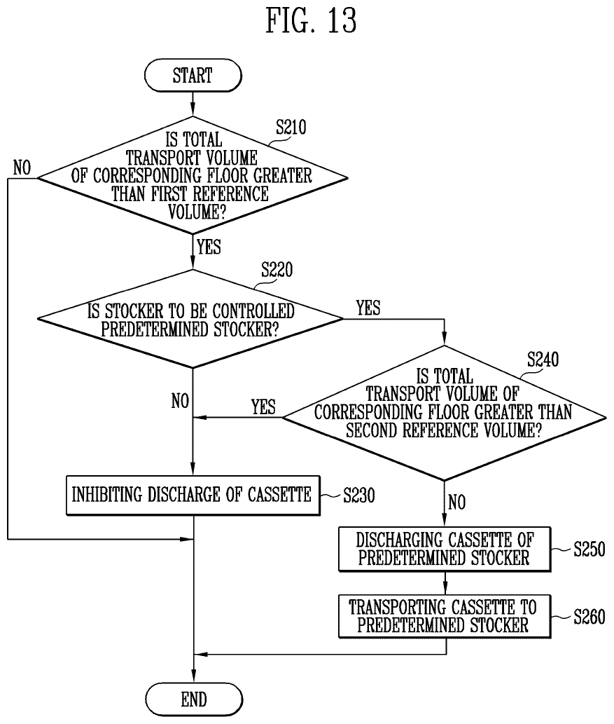

FIGS. 13 to 17 are diagram illustrating a logic of the cassette transport system shown in FIG. 12 in accordance with an embodiment of the disclosure.

Referring to FIG. 13, in an embodiment the cassette transport system 200 may perform a process S210 of determining whether a total transport volume of a corresponding floor is greater than a first reference volume, a process S220 of determining whether a stocker to be controlled (i.e., a stocker to which a cassette is to be discharged) is a predetermined stocker, a process S230 of inhibiting discharge of a cassette, a process S240 of determining whether the total transport volume of the corresponding floor is greater than a second reference volume, a process S250 of discharging a cassette of the predetermined stocker, and a process S260 of transporting a cassette to the predetermined stocker. Hereinafter, for convenience of description, a case where the cassette transport system 200 controls transportation of cassettes CST of the first floor 1F will be representatively described.

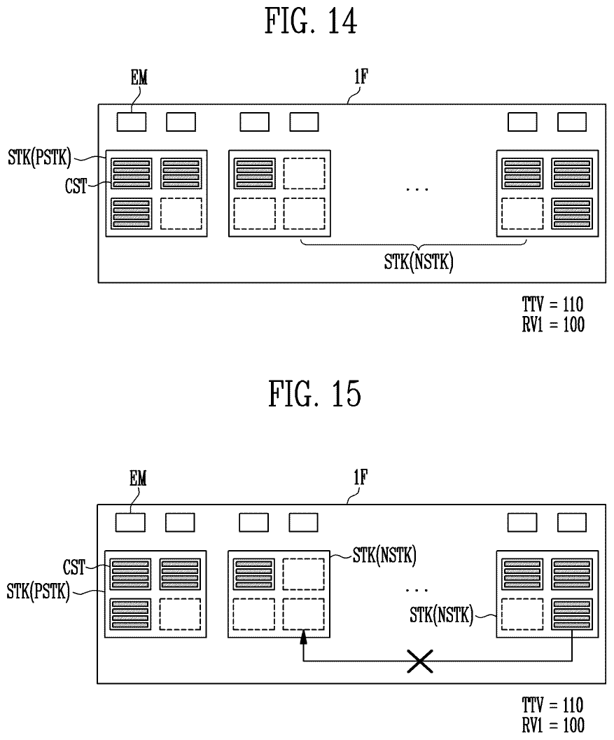

Referring to FIGS. 13 and 14, in the process S210, the controller CTL′ (see FIG. 12) may determine whether a total transport volume TTV of a corresponding floor is greater than a first reference volume RV1. The first reference volume RV1 is a threshold value for controlling transportation of cassettes CST stored in a normal stocker NSTK disposed on the corresponding floor, and may be predetermined to be stored in the controller CTL′. In an embodiment, the first reference volume RV1 may be set to the same value with respect to the first to third floors 1F to 3F (see FIG. 12), but embodiments are not necessarily limited thereto. In another embodiment, for example, the first reference volume RV1 may be set to different values with respect to the first to third floors 1F to 3F. Hereinafter, embodiments where the first reference volume RV1 is set to 100 will be described as an example. In an embodiment, for example, the controller CTL′ may calculate, as 110, a total transport volume TTV of cassettes CST disposed on the first floor 1F, and compare the total transport volume TTV with the first reference volume RV1. When the total transport volume TTV is smaller than the first reference volume RV1, the controller CTL′ may determine that transportation of the cassettes CST of the first floor 1F is smooth, and may not limit the transportation of the cassettes CST.

Referring to FIGS. 13 and 15, in the process S220, the controller CTL′ (see FIG. 12) may determine whether a stocker STK to be controlled is a predetermined stocker PSTK. The predetermined stocker PSTK is a stocker STK which is pre-specified based on a number of storable cassettes CST, a state of connected processing apparatuses EM, an operation rate of the processing apparatuses EM, and the like, and may be a stocker STK in which circulation of cassettes CST is to be sufficiently maintained unlike other stockers STK. The other stockers STK except the predetermined stocker PSTK among stockers STK may be specified as normal stockers NSTK. For convenience of illustration and description, a case where one stocker STK among stockers disposed on the first floor 1F is the predetermined stocker PSTK is shown in FIG. 15. However, embodiments are not necessarily limited thereto. For example, the number of predetermined stocker PSTK existing on the first floor 1F may be 2 or more.

When the stocker STK to be controlled is a normal stocker NSTK, in the process S230, the controller CTL′ may inhibit discharge of cassettes CST stored in the normal stocker NSTK. That is, the controller CTL′ may control transportation of the cassettes CST stored in the normal stocker NSTK, based on the total transport volume TTV and the first reference volume RV1.

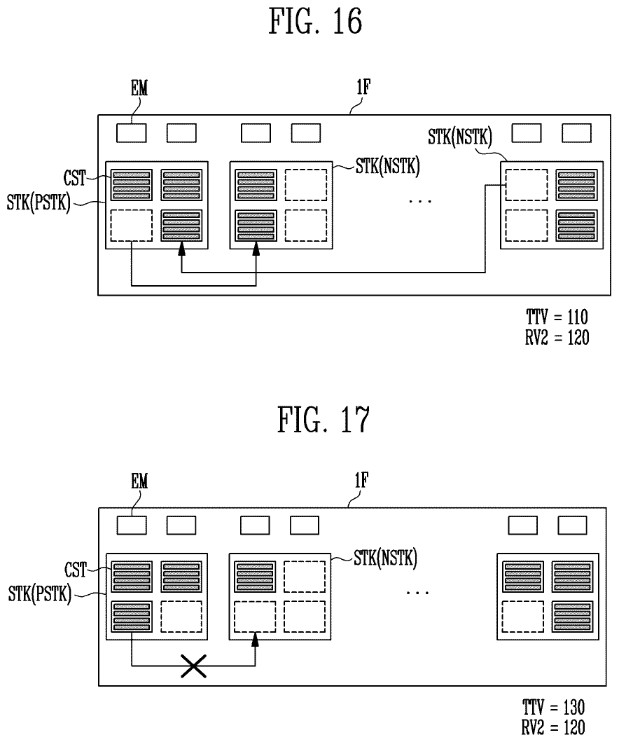

Referring to FIGS. 13 and 16, when the stocker STK to be controlled is a predetermined stocker PSTK, in the process S240, the controller CTL′ (see FIG. 12) may determine whether a total transport volume TTV of a corresponding floor is greater than a second reference volume RV2. The second reference volume RV2 is a threshold value for controlling transportation of cassettes CST stored in the predetermined stocker PSTK, and may be predetermined to be stored in the controller CTL′. The second reference volume RV2 may be set to a value greater than the first reference value RV1 (see FIG. 15). In an embodiment, the second reference volume RV2 may be set to the same value with respect to the first to third floors 1F to 3F (see FIG. 12), but embodiments are not necessarily limited thereto. In another embodiment, for example, the second reference volume RV2 may be set to different values with respect to the first to third floors 1F to 3F. Hereinafter, embodiments where the second reference volume RV2 is set to 120 will be described as an example. For example, the controller CTL′ may calculate, as 110, the total transport volume TTV of the cassettes CST disposed on the first floor 1F, and compare the total transport volume TTV with the second reference volume RV2.

When the total transport volume TTV is smaller than the second reference volume RV2, in the process S250, the controller CTL′ may control at least one of the cassettes CST stored in the predetermined stocker PSTK to be discharged. That is, the controller CTL′ may control transportation of the cassettes CST stored in the predetermined stocker PSTK, based on the total transport volume TTV and the second reference volume RV2.

In the process S260, the controller CTL′ may control a cassette CST to be transported to the predetermined stocker PSTK. For example, the controller CTL′ may control the cassette CST to be transported from the normal stocker NSTK to the predetermined stocker PSTK, thereby allow processing apparatuses EM connected to the predetermined stocker PSTK to smoothly secure cassettes CST necessary for a process.

Referring to FIGS. 13 and 17, when the total transport volume TTV is greater than the second reference volume RV2, the controller CTL′ (see FIG. 12) may determine that a transport volume of cassettes CST of the first floor 1F is excessive, and inhibit discharge of the cassettes CST stored in the predetermine stocker PSTK.

In an embodiment, as described above, the cassette transport system 200 (see FIG. 12) calculates a total transport volume TTV for each floor and compares the total transport volume TTV with the first reference volume RV1, thereby controlling discharge of cassettes CST stored in a normal stocker NSTK disposed on a corresponding floor. In such an embodiment, the cassette transport system 200 compares the total transport volume TTV with the second reference volume RV2 and maintains discharge of cassettes CST stored in a predetermined stock PSTK disposed on the corresponding floor, thereby securing a storage space. Also, the cassette transport system 200 pre-emptively transports cassettes CST to the predetermined stocker PSTK, thereby increasing an operation rate of processing apparatuses EM connected to the predetermined stocker PSTK.

In accordance with embodiments of the invention, a cassette transport system may effectively prevent a transportation delay of cassettes.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A cassette transport system comprising:
stockers which store cassettes accommodating substrates therein;
processing apparatuses respectively connected to the stockers; and
a controller which controls a transportation of the cassettes,
wherein the controller selects, as a first stocker, a stocker of which a storage modulus is greater than or equal to a reference storage modulus among the stockers, and controls dischargeable cassettes among the cassettes stored in the first stocker to be sequentially discharged from the first stocker according to a predetermined order.

2. The cassette transport system of claim 1, wherein the dischargeable cassettes include a first cassette, a second cassette, a third cassette, a fourth cassette, a fifth cassette, and a sixth cassette,
wherein the first cassette is a cassette to be used in a processing apparatus connected to a second stocker different from the first stocker among the stockers,
wherein the second cassette is a cassette expected to be used in a processing apparatus connected to a third stocker different from the first stocker among the stockers,
wherein the third cassette is a cassette which is not used in a processing apparatus connected to the first stocker,
wherein the fourth cassette is a cassette subject to cleaning,
wherein the fifth cassette is a cassette expected to be cleaned, and
wherein the sixth cassette is a cassette stored in the first stocker over a time exceeding a predetermined time.

3. The cassette transport system of claim 2, wherein the controller controls the first cassette first in the predetermined order among the dischargeable cassettes to be discharged from the first stocker to the second stocker.

4. The cassette transport system of claim 3, wherein, when a storage modulus of the second stocker is lower than the reference storage modulus, the controller controls the first cassette not to be discharged from the first stocker.

5. The cassette transport system of claim 3, wherein the controller controls the second cassette second in the predetermined order among the dischargeable cassettes to be discharged from the first stocker to the third stocker.

6. The cassette transport system of claim 5, wherein, when a storage modulus of the third stocker is lower than the reference storage modulus, the controller controls the second cassette not to be discharged from the first stocker.

7. The cassette transport system of claim 5, wherein the controller controls the third cassette third in the predetermined order among the dischargeable cassettes to be discharged from the first stocker to a fourth stocker among the stockers.

8. The cassette transport system of claim 7, wherein, when a storage modulus of the fourth stocker is lower than the reference storage modulus, the controller controls the third cassette not to be discharged from the first stocker.

9. The cassette transport system of claim 7, wherein the controller controls the fourth cassette fourth in the predetermined order among the dischargeable cassettes to be discharged from the first stocker to a fifth stocker among the stockers.

10. The cassette transport system of claim 9, wherein, when a storage modulus of the fifth stocker is lower than the reference storage modulus, the controller controls the fourth cassette not to be discharged from the first stocker.

11. The cassette transport system of claim 9, wherein the controller controls the fifth cassette fifth in the predetermined order among the dischargeable cassettes to be discharged from the first stocker to the fifth stocker.

12. The cassette transport system of claim 11, wherein, when a storage modulus of the fifth stocker is lower than the reference storage modulus, the controller controls the fifth cassette not to be discharged from the first stocker.

13. The cassette transport system of claim 11, wherein the controller controls the sixth cassette sixth in the predetermined order among the dischargeable cassettes to be discharged from the first stocker to a sixth stocker among the stockers.

14. The cassette transport system of claim 13, wherein, when a storage modulus of the sixth stocker is lower than the reference storage modulus, the controller controls the sixth cassette not to be discharged from the first stocker.

15. A cassette transport system comprising:
stockers disposed on a plurality of floors in a factory, wherein the stockers store cassettes accommodating substrates therein;
processing apparatuses respectively connected to the stockers; and
a controller which controls a transportation of the cassettes, based on a total transport volume of the cassettes calculated for each floor,
wherein the controller:
controls cassettes stored in a normal stocker among stockers disposed on a corresponding floor not to be discharged, when the total transport volume is greater than a first reference volume; and
controls at least one of cassettes stored in a predetermined stocker among the stockers disposed on the corresponding floor to be discharged, when the total transport volume is greater than the first reference volume and is smaller than a second reference volume greater than the first reference volume.

16. The cassette transport system of claim 15, wherein, when the total transport volume is greater than the second reference volume, the controller controls the cassettes stored in the predetermined stocker not to be discharged.

17. The cassette transport system of claim 16, wherein the controller controls at least one of the cassettes stored in the normal stocker to be transported to the predetermined stocker.
